(19) United States
(12) Patent Application Publication
(10) Pub. No.: US 2007/0119989 A1
(43) Pub. Date: May 31, 2007

(54) Flow channel switching valve and shower system

(76) Inventors: Fusayuki Nagano, Gifu-ken (JP); Takahiko Shindo, Gifu-ken (JP); Shinobu Kanou, Gifu-ken (JP)

Correspondence Address: MARSH, FISCHMANN & BREYFOGLE LLP, 3151 SOUTH VAUGHN WAY, SUITE 411, AURORA, CO, 80014, US

(21) Appl. No.: 10/574,395

(22) PCT Filed: Sep. 29, 2004
(86) PCT No.: PCT/JP04/14270

§ 371 Date: Mar. 30, 2006

(30) Foreign Application Priority Data
Sep. 30, 2003 (JP) 2003-339821
Dec. 25, 2003 (JP) 2003-431649

(51) Int. Cl. B05B 9/01; B05B 9/08; B05B 7/02

(52) U.S. Cl. 239/526; 239/525; 239/530

(57) ABSTRACT

A channel switching valve (A) of the present invention includes a discharge hole (14) which discharges water having a proper temperature and a drain hole (15) which drains water having an improper temperature. A part of a first channel (11) extending from a hot water supply port (24b) to the discharge hole and a part of a second channel (11) extending from the hot water supply port to the drain hole are common. Therefore, the channel switching valve can be compact.

### TECHNICAL FIELD

The present invention relates to a channel switching valve and a shower system.

### BACKGROUND ART

Conventionally, as a channel switching valve, an arrangement disclosed in Patent Document 1 is known, for example. The channel switching valve comprises a temperature sensitive spring which reversibly changes its shape depending on the temperature of fluid flowing into the inside of the channel switching valve and a valve body which is biased by the temperature sensitive spring. When load is applied to the valve body with change in shape of the temperature sensitive spring, the valve body moves to switch between a state in which a drain port for fluid having a proper temperature, which is fluid having a temperature in a predetermined temperature range, is linked to the channel and a state in which a drain port for fluid having an improper temperature, which is fluid having a temperature out of a predetermined temperature range, is linked to the channel.

If this kind of channel switching valve is applied to a shower system which is used in a bath, for example, it is possible to have an arrangement in which hot water, which is water having a proper temperature, is drained from a shower head while cold water or scalding water, which is water having an improper temperature, is drained from a drain port different from the shower head. In this case, a user does not feel uncomfortable due to cold water or scalding water being suddenly drained from the shower head.

However, in the above described channel switching valve, the user cannot intentionally cause water having an improper temperature to be drained from the shower head. For example, if cold water is required in the summer or if scalding water is required in the winter, the user cannot cause cold water or scalding water to be drained from the shower head.

In order to resolve such a problem, Patent Document 2 discloses an improved shower system which can drain not only water having a proper temperature, but also water having an improper temperature as required, from a shower head. The shower system comprises a relief mechanism for water having an improper temperature which inhibits water having an improper temperature to be drained from the shower head, a bypass channel provided so as to bypass the relief mechanism, and a switching valve for opening or closing the bypass channel. In this shower system, when a user desires to allow water having an improper temperature to be drained from the shower head, he/she may open the bypass channel by operating the switching valve. In this way, water having an improper temperature is drained from the shower head through the bypass channel, without passing through the relief mechanism.

However, in the shower system in Patent Document 2, it is required that a channel for draining water having a proper temperature from the shower head and a channel (the above described bypass channel) for draining water having an improper temperature from the shower head be separately provided. Therefore, this shower system is relatively large and requires a large installation space. Thus, if the space in a bath is small, the shower system cannot be installed.

Patent Document 1: Japanese Patent Laid-Open No. 10-299926

Patent Document 2: Japanese Patent Laid-Open No. 2003-=b 24232

### DISCLOSURE OF THE INVENTION

It is a purpose of the present invention to provide a more compact channel switching valve which can drain not only fluid having a proper temperature, but also fluid having an improper temperature as required through a drain port for draining fluid having proper temperature. It is also a purpose of the present invention to provide a shower system comprising such a channel switching valve.

To achieve the above described purposes, in one aspect of the present invention, a channel switching valve is provided. The channel switching valve includes a valve casing, a valve body, and valve body activating means. The valve casing includes a fluid supply port for supplying fluid into the valve casing, a first drain port for draining fluid having a temperature out of a predetermined temperature range, which is supplied into the valve casing through the fluid supply port, a second drain port for draining fluid having a temperature in the predetermined temperature range, which is supplied into the valve casing through the fluid supply port, a first channel connecting the fluid supply port to the first drain port, a second channel connecting the fluid supply port to the second drain port, a first valve hole provided in the middle of the first channel, a second valve hole provided in the middle of the second channel, a first valve seat provided corresponding to the first valve hole, and a second valve seat provided corresponding to the second valve hole. The valve body moves between a first position in which the valve body contacts the first valve seat to close the first valve hole and a second position in which the valve body contacts the second valve seat to close the second valve hole. The valve body activating means allows the valve body to be placed in the first position or the second position based on the temperature of the fluid. A part of the first channel and a part of the second channel are common. The channel switching valve further includes lock means which forcefully moves the valve body to the first position and holds the valve body in the first position.

In another aspect of the present invention, a shower system is provided. The shower system includes the above described channel switching valve, a hose and a shower head. The shower head is connected to a first drain port of the channel switching valve through the hose.

Also, the present invention provides another channel switching valve as described below. The channel switching valve includes a body in which a channel is formed through which fluid passes, a discharge hole which is opened in the body to supply the fluid to a subsequent element, a drain hole which is opened in the body to drain the fluid if the temperature of the fluid is out of a predetermined temperature range, a valve body which is accommodated in the channel and opens or closes either a part of the channel connecting to the discharge hole or a part of the channel connecting to the drain hole, a first temperature sensitive element which is accommodated in the channel so as to bias the valve body in a predetermined direction, and a bias spring and a second temperature sensitive element which are accommodated in the channel so as to bias the valve body in a direction opposite to the predetermined direction. Biasing forces of the first temperature sensitive element and the second temperature sensitive element individually change depending on the temperature of the fluid. If the temperature of the fluid is out of the predetermined temperature range, the valve body moves to allow the fluid to be drained from the drain hole due to the sum of the biasing force of the bias spring and the biasing force of the second temperature sensitive element being larger than the biasing force of the first temperature sensitive element. A handle for forcefully moving the valve body in the channel is connected to the valve body. By operating the handle, the valve body is moved to close the part of the channel connecting to the drain hole.

### BRIEF DESCRIPTION OF THE DRAWINGS

FIG. 1 is a diagrammatic view of a channel switching valve according to a first embodiment which is placed between a combination faucet and a shower head;

FIG. 2 is a cross sectional view of the channel switching valve shown in FIG. 1 in a state of discharging water having a proper temperature from a discharge hole;

FIG. 3 is a cross sectional view of the channel switching valve shown in FIG. 1 in a state of draining water having an improper temperature from a drain hole;

FIG. 4 is a cross sectional view of the channel switching valve shown in FIG. 1 in a state of discharging water having an improper temperature from the discharge hole;

FIG. 5 is a cross sectional view of a channel switching valve according to a second embodiment in a state of discharging water having a proper temperature from the discharge hole;

FIG. 6 is a cross sectional view of a channel switching valve according to the second embodiment in a state of draining water having an improper temperature from the drain hole;

FIG. 7 is a cross sectional view of a channel switching valve according to the second embodiment in a state of discharging water having an improper temperature from the discharge hole;

FIG. 8 is an exploded perspective view showing a latch mechanism which alternately opens and closes the drain hole and the discharge hole of the channel switching valve according to the second embodiment;

FIG. 9 is a developed view of a part of the latch mechanism shown in FIG. 8;

FIG. 10 is a cross sectional view of a channel switching valve according to a third embodiment in a state of discharging water having a proper temperature from the discharge hole;

FIG. 11 is a cross sectional view of a channel switching valve according to the third embodiment in a state of draining water having an improper low temperature from the drain hole;

FIG. 12 is a cross sectional view of a channel switching valve according to the third embodiment in a state of draining water having an improper high temperature from the drain hole;

FIG. 13 is a cross sectional view of a channel switching valve according to the third embodiment in a state of forcefully discharging water having an improper low temperature from the discharge hole;

FIG. 14 is a cross sectional view of a channel switching valve according to the third embodiment in a state of forcefully discharging water having an improper hot temperature from the discharge hole; and

FIG. 15 is a graph showing temperature characteristics of first and second wax thermoelements.

### BEST MODE FOR CARRYING OUT THE INVENTION

Now, a first embodiment of the present invention will be described with reference to the drawings.

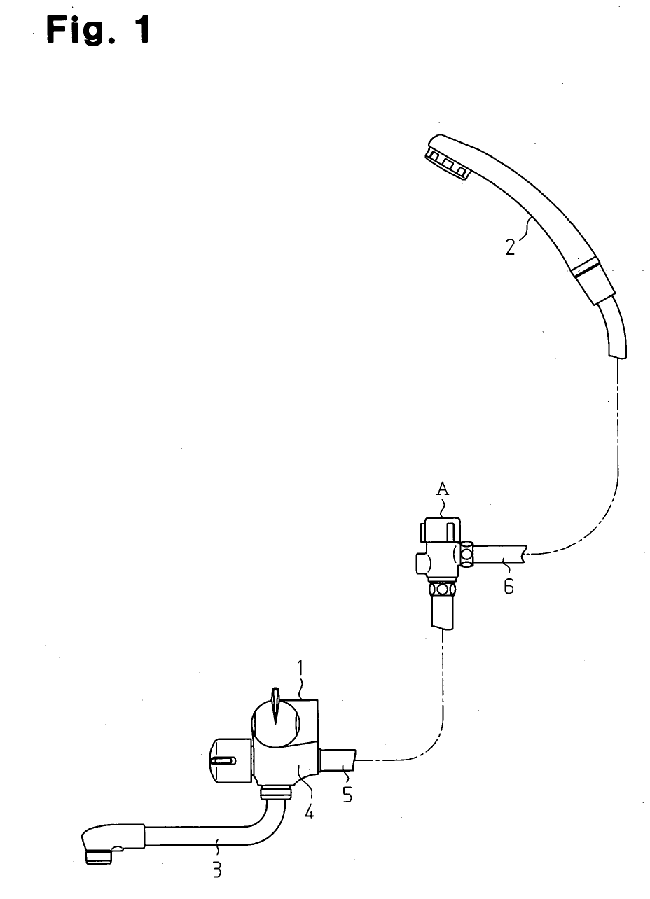

As shown in FIG. 1, a channel switching valve A according to this embodiment is attached between a combination faucet 1 and a shower head 2 in a bathroom, for example. A supply tube 5 is connected to the combination faucet 1 which adjusts temperature and flow rate of water which is a fluid. The combination faucet 1 comprises a switching valve 4 such that the water, which is adjusted in temperature and flow rate, is selectively supplied to either the supply tube 5 or a water discharge tube 3 of the combination faucet 1 by operating the switching valve 4. The supply tube 5 is linked to a hose 6 through the channel switching valve A. The shower head 2 is attached at a tip of the hose 6. The channel switching valve A, the shower head 2 and the hose 6 constitute a shower system.

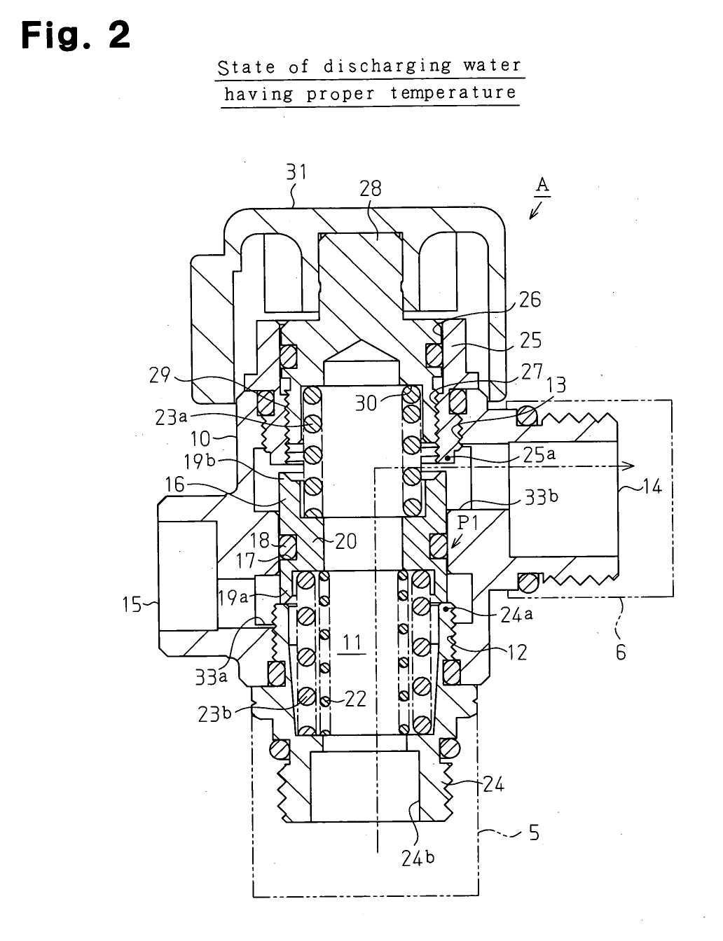

As shown in FIG. 2, the channel switching valve A comprises a hollow body 10. A first opening hole 12 is provided in one end (a lower end in FIG. 2) of the body 10. A first lid member 24 is attached to the first opening hole 12. The first lid member 24 comprises a hot water supply port 24b as a fluid supply port. In the other end (an upper end in FIG. 2) of the body 10, a second opening hole 13 is provided. A second lid member 25 is attached to the second opening hole 13. The body 10, the first lid member 24 and the second lid member 25 constitute a valve casing. The valve casing comprises a channel 11 therein. Water, which is supplied from the combination faucet 1 to the supply tube 5, flows through the hot water supply port 24b into the channel 11.

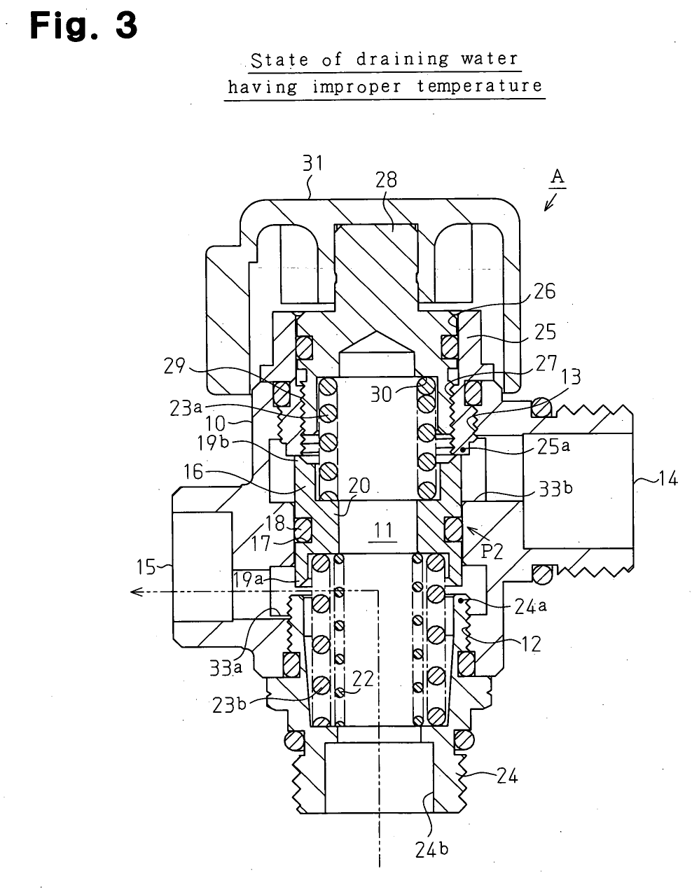

In a circumferential wall of the body 10, a drain hole 15 as a first drain port and a discharge hole 14 as a second drain port are provided. If the temperature of the water from the combination faucet 1 is in a predetermined temperature range, i.e., if the water from the combination faucet 1 has a proper temperature, the water from the combination faucet 1 is discharged from the discharge hole 14. If the temperature of the water from the combination faucet 1 is out of the predetermined temperature range, i.e., if the water from the combination faucet 1 has an improper temperature, the water from the combination faucet 1 is drained from the drain hole 15. That is, the water from the combination faucet 1 is selectively discharged from the discharge hole 14 or drained from the drain hole 15, depending on the temperature of the water. In this embodiment, a temperature higher than 35° C. and lower than 45° C. is a proper temperature while a temperature equal to or lower than 35° C. or equal to or higher than 45° C. is an improper temperature. The discharge hole 14 and the drain hole 15 are placed in mutually different positions with respect to the flow direction of the water flowing through the channel 11. Specifically, the discharge hole 14 is located downstream in comparison with the drain hole 15. Both the discharge hole 14 and the drain hole 15 link to the hot water supply port 24b through the channel 11. That is, the channel 11 includes a first channel from the hot water supply port 24b to the drain hole 15 (an arrow with a two-dot chain line shown in FIG. 3) and a second channel from the hot water supply port 24b to the discharge hole 14 (an arrow with a two-dot chain line shown in FIG. 2), wherein a part of the first channel and a part of the second channel are common (overlapped).

A first valve hole 33a is provided in the midway of a section of the channel 11 from the hot water supply port 24b to the drain hole 15. A second valve hole 33b is provided in the midway of a section of the channel 11 from the hot water supply port 24b to the discharge hole 14. The first valve hole 33a and the second valve hole 33b are placed in mutually different positions with respect to the flow direction of the water flowing through the channel 11. Specifically, the second valve hole 33b is located downstream in comparison with the first valve hole 33a.

In the channel 11, a generally cylindrical valve body 16 is accommodated. In the middle of an outer circumference of the valve body 16, an annular groove 17 is provided which extends circumferentially. A seal member 18 is attached to the annular groove 17 so as to closely contact to an outer surface of the valve body 16 and an inner surface of the channel 11.

The valve body 16 has a first annular end face 19a which is located adjacent to the first lid member 24 on one end (a lower end in FIG. 2) and a second annular end face 19b which is located adjacent to the second lid member 25 on the other end (an upper end in FIG. 2). The valve body 16 can move between a first position P1 shown in FIG. 2 where the first end face 19a of the valve body 16 contacts an upper end face of the first lid member 24 which acts as a first valve seat 24a, and a second position P2 shown in FIG. 3 where the second end face 19b of the valve body 16 contacts a lower end face of the second lid member 25 which acts as a second valve seat 25a. When the valve body 16 is in the first position P1, the second valve hole 33b is opened as shown in FIG. 2. Therefore, the water from the combination faucet 1 is discharged from the discharge hole 14. On the other hand, when the valve body 16 is in the second position P2, the first valve hole 33a is opened as shown in FIG. 3. Therefore, the water from the combination faucet 1 is drained from the drain hole 15.

In the channel 11, there are accommodated a first temperature sensitive element 23a which biases the valve body 16 toward the first position P1 (toward the downstream side) and a second temperature sensitive element 23b and a bias spring 22 which bias the valve body 16 toward the second position P2 (toward the upstream side). The first temperature sensitive element 23a and the second temperature sensitive element 23b are coil springs made of shape memory alloy and transform so as to expand or contract in an axial direction depending on the temperature of the water from the combination faucet 1. The first temperature sensitive element 23a, which is located downstream (upside in FIG. 2) in comparison with the valve body 16, expands if the temperature of the water from the combination faucet 1 is in the predetermined temperature range. The second temperature sensitive element 23b, which is located upstream (downside in FIG. 2) in comparison with the valve body 16, expands if the temperature of the water from the combination faucet 1 is in a different temperature range from the above described predetermined temperature range. Thus, biasing forces of the first temperature sensitive element 23a and the second temperature sensitive element 23b individually change depending on the temperature of the water from the combination faucet 1. On the other hand, biasing force of the bias spring 22 placed in the second temperature sensitive element 23b is independent of the temperature of the water from the combination faucet 1. The bias spring 22, the first temperature sensitive element 23a and the second temperature sensitive element 23b constitute valve body actuating means, which allows the valve body 16 to be placed in the first position P1 or the second position P2 based on the temperature of the water from the combination faucet 1.

One end (a lower end in FIG. 2) of the first temperature sensitive element 23a contacts a collar part 20 which is provided in the middle of the inner circumference of the valve body 16. The other end (an upper end in FIG. 2) of the first temperature sensitive element 23a contacts a plug 28 which is threadably engaged with the second lid member 25. One end (an upper end in FIG. 2) of the bias spring 22 and the second temperature sensitive element 23b contacts the collar part 20. The other end (a lower end in FIG. 2) of the bias spring 22 and the second temperature sensitive element 23b contacts the first lid member 24.

If the temperature of the water passing through the channel 11 is equal to or lower than 35° C., neither of the first and second temperature sensitive elements 23a, 23b extend. In this case, load applied to the valve body 16 by the first temperature sensitive element 23a is smaller than load applied to the valve body 16 by the bias spring 22 and the second temperature sensitive element 23b. In other words, the biasing force of the first temperature sensitive element 23a which biases the valve body 16 toward the upstream side (downside in FIG. 2) is smaller than the sum of the biasing force of the bias spring 22 and the biasing force of the second temperature sensitive element 23b which bias the valve body 16 toward the downstream side (upside in FIG. 2). Therefore, the valve body 16 moves upwardly to be placed in the second position P2 as shown in FIG. 3.

If the temperature of the water passing through the channel 11 is equal to or higher than 45° C., only the second temperature sensitive element 23b extends and the first temperature sensitive element 23a does not extend. Also in this case, the biasing force of the first temperature sensitive element 23a which biases the valve body 16 downwardly is smaller than the sum of the biasing force of the bias spring 22 and the biasing force of the second temperature sensitive element 23b which bias the valve body 16 upwardly. Therefore, the valve body 16 moves upwardly to be placed in the second position P2.

If the temperature of the water passing through the channel 11 is higher than 35° C. and lower than 45° C., only the first temperature sensitive element 23a extends and the second temperature sensitive element 23b does not extend. In this case, the load applied to the valve body by the first temperature sensitive element 23a is larger than the load applied to the valve body 16 by the bias spring 22 and the second temperature sensitive element 23b. In other words, the biasing force of the first temperature sensitive element 23a which biases the valve body 16 downwardly is larger than the sum of the biasing force of the bias spring 22 and the biasing force of the second temperature sensitive element 23b that bias the valve body 16 upwardly. Therefore, the valve body 16 moves downwardly to be placed in the first position P1 as shown in FIG. 2.

The second lid member 25 is generally cylindrical in shape and has a through hole 26 which extends in an axial center direction. On an inner circumferential surface of the through hole 26, an internally threaded part 27 is provided. The plug 28 has an externally threaded part 29 corresponding to the internally threaded part 27. A part of the plug 28 is inserted in the through hole 26 with the externally threaded part 29 of the plug 28 engaged with the internally threaded part 27 of the second lid member 25. A handle 31 is connected to a tip of the plug 28. The plug 28 has an annular support part 30 on its inner circumference and the upper end of the first temperature sensitive element 23a contacts the support part 30. When the handle 31 is rotated so that the plug 28 is threaded into the second lid member 25 or the plug 28 moves downwardly, the valve body 16 moves to the first position P1 and is held in that position. The plug 28 and the handle 31 constitute lock means which moves the valve body 16 forcefully to the first position P1 and holds the valve body 16 in the first position P1.

Then, an operation of the channel switching valve A will be described.

If the temperature of water supplied from the combination faucet 1 to the channel switching valve A is higher than 35° C. and lower than 45° C., only the first temperature sensitive element 23a extends and the second temperature sensitive element 23b does not extend. Therefore, as shown in FIG. 2, the valve body 16 moves downwardly to be placed in the first position P1 by the biasing force of the first temperature sensitive element 23a being larger than the sum of the biasing force of the bias spring 22 and the biasing force of the second temperature sensitive element 23b. As a result, the first end face 19a of the valve body 16 is located on (contacts) the first valve seat 24a of the first lid member 24 so that the first valve hole 33a is closed. Therefore, the water in the channel 11 is discharged from the discharge hole 14 through the second valve hole 33b and supplied to the hose 6. In this way, the water having a proper temperature higher than 35° C. and lower than 45° C. is discharged from the shower head 2.

If the temperature of water supplied from the combination faucet 1 to the channel switching valve A is equal to or lower than 35° C., neither of the first and second temperature sensitive elements 23a, 23b extends. Therefore, as shown in FIG. 3, the valve body 16 moves upwardly to be placed in the second position P2 by the biasing forces of the bias spring 22 and the second temperature sensitive element 23b being larger than the biasing force of the first temperature sensitive element 23a. As a result, the second end face 19b of the valve body 16 is located on (contacts) the second valve seat 25a of the second lid member 25 so that the second valve hole 33b is closed. Therefore, through the first valve hole 33a, the water in the channel 11 is drained from the drain hole 15 to the outside. Thus, water having an improper temperature equal to or lower than 35° C. is not discharged from the shower head 2.

If the temperature of water supplied from the combination faucet 1 to the channel switching valve A is equal to or higher than 45° C., only the second temperature sensitive element 23b extends and the first temperature sensitive element 23a does not extend. Therefore, as shown in FIG. 3, the valve body 16 moves upwardly to be placed in the second position P2 by the biasing forces of the bias spring 22 and the second temperature sensitive element 23b being larger than the biasing force of the first temperature sensitive element 23a. As a result, the second end face 19b of the valve body 16 is located on (contacts) the second valve seat 25a of the second lid member 25 so that the second valve hole 33b is closed. Therefore, through the first valve hole 33a, the water in the channel 11 is drained from the drain hole 15 to the outside. Thus, the water having an improper temperature equal to or higher than 45° C. is also not discharged from the shower head 2.

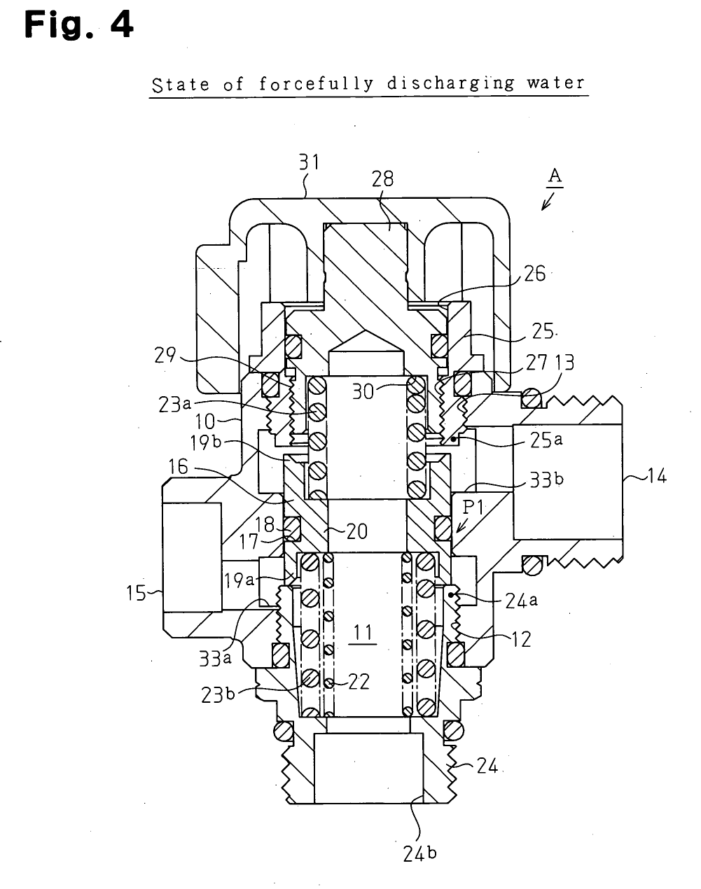

If it is desired that water having an improper temperature equal to or lower than 35° C. or equal to or higher than 45° C. be discharged from the shower head 2, the handle 31 is rotated so that the plug 28 moves downwardly. Thereby, the first temperature sensitive element 23a is compressed by the plug 28 such that the valve body 16 is downwardly biased through the first temperature sensitive element 23a to move to the first position P1, as shown in FIG. 4. As a result, the first end face 19a of the valve body 16 is located on the first valve seat 24a of the first lid member 24 so that the first valve hole 33a is closed. Spring force of the first temperature sensitive element 23a, which is enhanced by the compression, is enough large to continue to hold the valve body 16 in the first position P1, even if the second temperature sensitive element 23b extends. Therefore, the water from the combination faucet 1 is not drained from the drain hole 15, but discharged from the discharge hole 14. In this way, not only water having a proper temperature, but also water having an improper temperature as required can be discharged from the discharge hole 14.

This embodiment has following advantages.

(1) In the channel switching valve A shown in FIG. 1, a part of the first channel for draining water having a proper temperature from the shower head 2 and a part of the second channel for draining water having an improper temperature from the shower head 2 are common. Therefore, the channel switching valve A is compact in comparison with the case in which the first channel and the second channel is completely separately provided.

(2) Even if water having an improper temperature flows in the channel 11, the valve body 16 moves to the first position P1 by rotating the handle 31. Therefore, water having an improper temperature can be discharged from the shower head 2, as required.

(3) The first and second temperature sensitive elements 23a, 23b made of shape memory alloy extend or contract depending on the temperature of water from the combination faucet 1, which allows the valve body 16 to move without relying on electrical power. Therefore, the channel switching valve A can be installed when installation space permits, even in a place where no power supply is provided. Further, because a power supply is not required, a structure for preventing electrical leakage is unnecessary in the channel switching valve A. This contributes to downsizing and low cost of the channel switching valve A. In addition, by using the first temperature sensitive element 23a and the second temperature sensitive element 23b which allow the valve body 16 to move without relying on electrical power, no actuation noise is generated when the valve body 16 is moved.

(4) Because the valve body 16 is placed in the channel 11 in the valve casing, space saving for the body 10 may be realized so that the channel switching valve A can be more compact.

(5) Because the valve body 16 is shaped like a tube in order to guide water flowing from the hot water supply port 24b to the discharge hole 14, weight reduction of the valve body 16 may be realized. As a consequence, responsivity improves when the valve body 16 moves and thus it is possible to speed up the open/close switching of the discharge hole 14 and the drain hole 15. Also, the weight reduction of the valve body 16 contributes to weight reduction of the channel switching valve A.

Next, a second embodiment of the present invention will be described with reference to the drawings. Points which are different from the first embodiment will now be mainly described and the same or similar components will be designated by the same reference symbol as in the first embodiment and description of the components will be omitted.

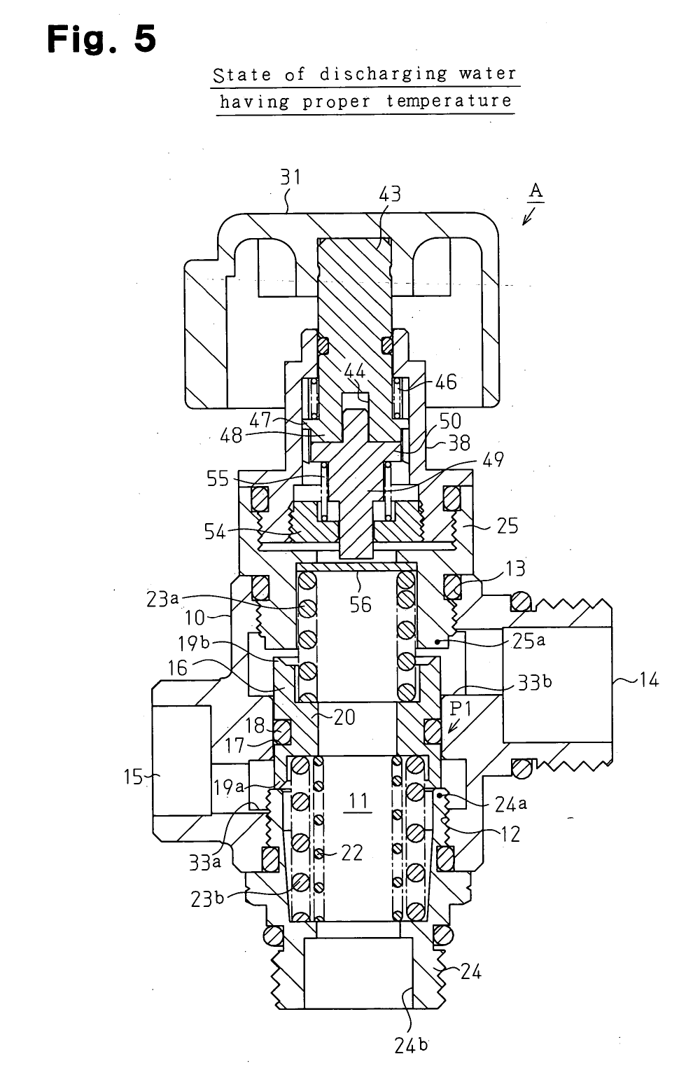

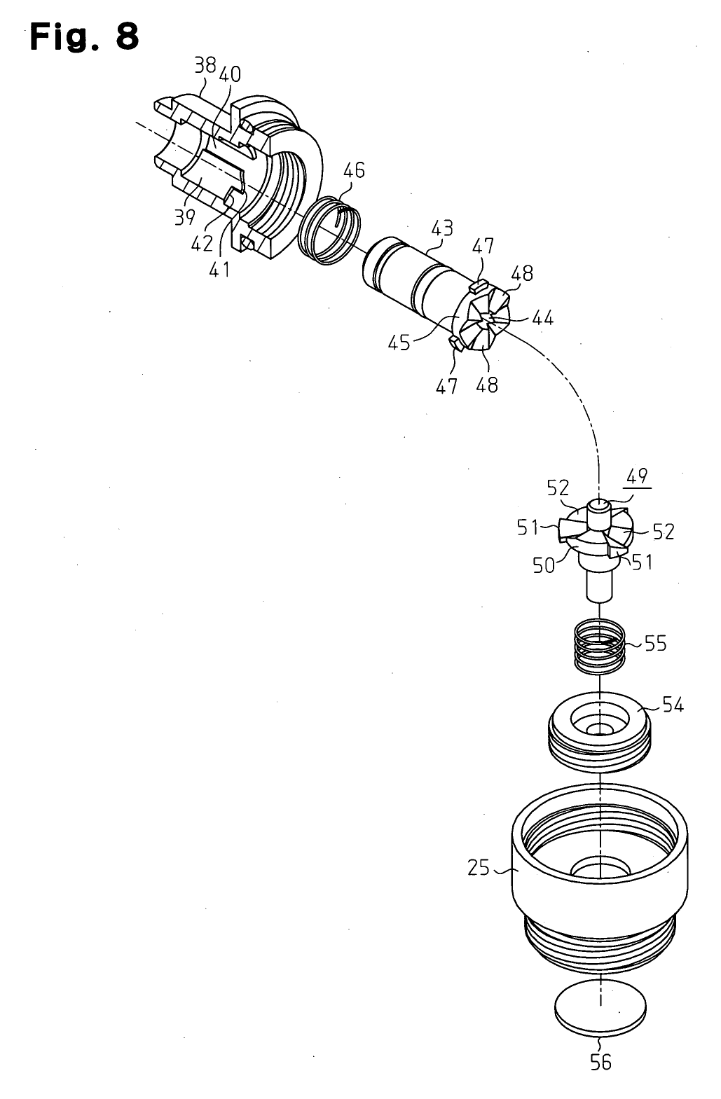

As shown in FIG. 5 and FIG. 8, a tube body 38 is threadably engaged with the second lid member 25 of the channel switching valve A. In an inner circumferential surface of the tube body 38, three protruding strips 39 are formed at even intervals to extend in an axial direction. Vertical grooves 40 are formed between these protruding strips 39. On an end of each protruding strip 39, respective sawtooth surface 41 is formed. With the sawtooth surfaces 41, stopper parts 42 are formed so as to be located in the middle part between adjacent vertical grooves 40.

In the tube body 38, an operating shaft 43 is inserted to project from an upper end face of the tube body 38. A handle 31 is attached to an upper end of the operating shaft 43. A support hole 44 is formed in the middle of a lower end of the operating shaft 43. A flange part 45 is formed on an outer circumference of the lower end of the operating shaft 43. A coil spring 46 is provided between the flange part 45 of the operating shaft 43 and the tube body 38. Due to biasing force of the coil spring 46, the operating shaft 43 is outwardly biased.

On an outer circumferential surface of the flange part 45 of the operating shaft 43, three engaging protrusions 47 are provided at even intervals. On an end face of the flange part 45, six gable cam faces 48 are formed at even intervals. The operating shaft 43 can move in the axial direction of the tube body 38 by each engaging protrusion 47 of the operating shaft 43 slidably engaging with a respective vertical groove 40 of the tube body 38.

In the support hole 44 of the operating shaft 43, a rotatable body 49 is inserted and supported so that it can relatively rotate and relatively move in the axial direction. A flange part 50 is formed on the middle outer circumference of the rotatable body 49. On an outer circumferential surface of the flange part 50, three engaging protrusions 51 are provided at even intervals, which can engage to the vertical grooves 40 of the tube body 38 and the stopper parts 42. On an end face of the flange part 50 which opposes to the flange part 45 on the above described operating shaft 43, six inclined faces 52 are formed at even intervals, which can engage with the gable cam faces 48 of the operating shaft 43.

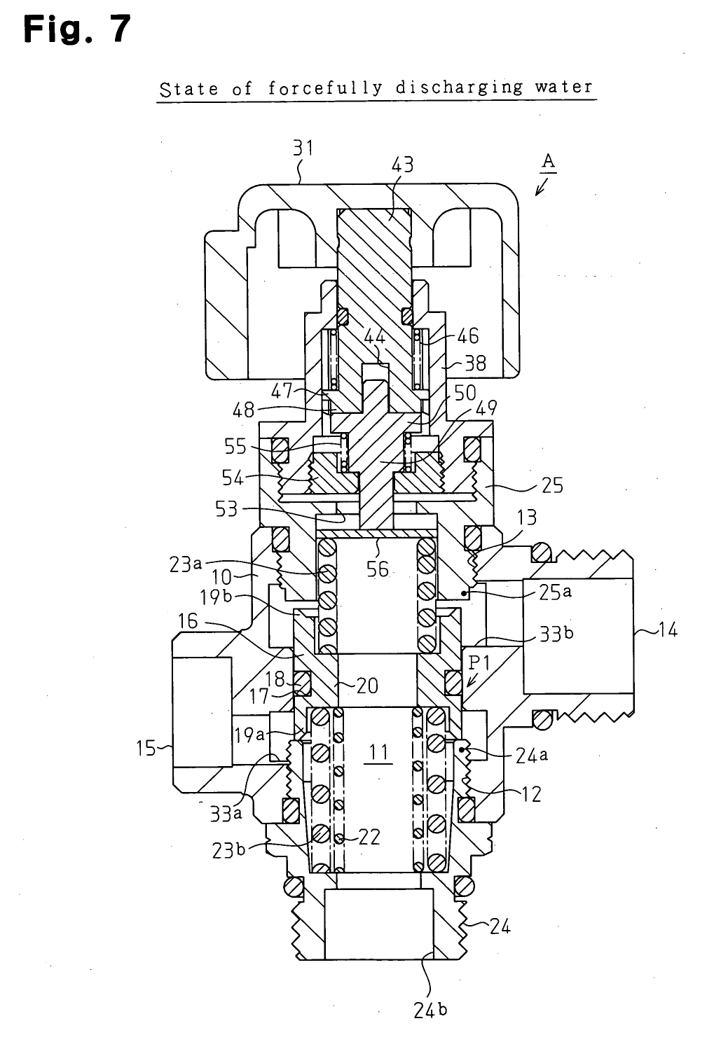

In a lower end in the tube body 38, the rotatable body 49 is inserted and supported so that it can move through a support tube 54 in the axial direction. A tip of the rotatable body 49 is placed in the channel 11 through the through hole 53 (see FIG. 7) formed in the second lid member 25 and can contact a pressure plate 56 which is put on an end of the first temperature sensitive element 23a. A pressure spring 55 is fitted on the rotatable body 49. One end of the pressure spring 55 is fixed to the flange part 50 of the rotatable body 49 and the other end is fixed to the support tube 54. The rotatable body 49 is biased by the pressure spring 55 to outwardly move, such that the inclined faces 52 of the rotatable body 49 are engaged with the gable cam faces 48 of the operating shaft 43.

An operation of the channel switching valve A in this embodiment will be described.

As shown in FIG. 5, when water having a proper temperature is supplied from the combination faucet 1 to the body 10 of the channel switching valve A in a state in which the tip of the rotatable body 49 is separated from the pressure plate 56 and the first temperature sensitive element 23a is not forcefully compressed from the outside, the valve body 16 is moved to the first position Pi so that the first end face 19a of the valve body 16 is seated on (contacts) the first valve seat 24a in the first lid member 24. As a result, linkage between the channel 11 and the drain hole 15 is blocked while linkage between the channel 11 and the discharge hole 14 is allowed and thus water having a proper temperature is discharged from the discharge hole 14.

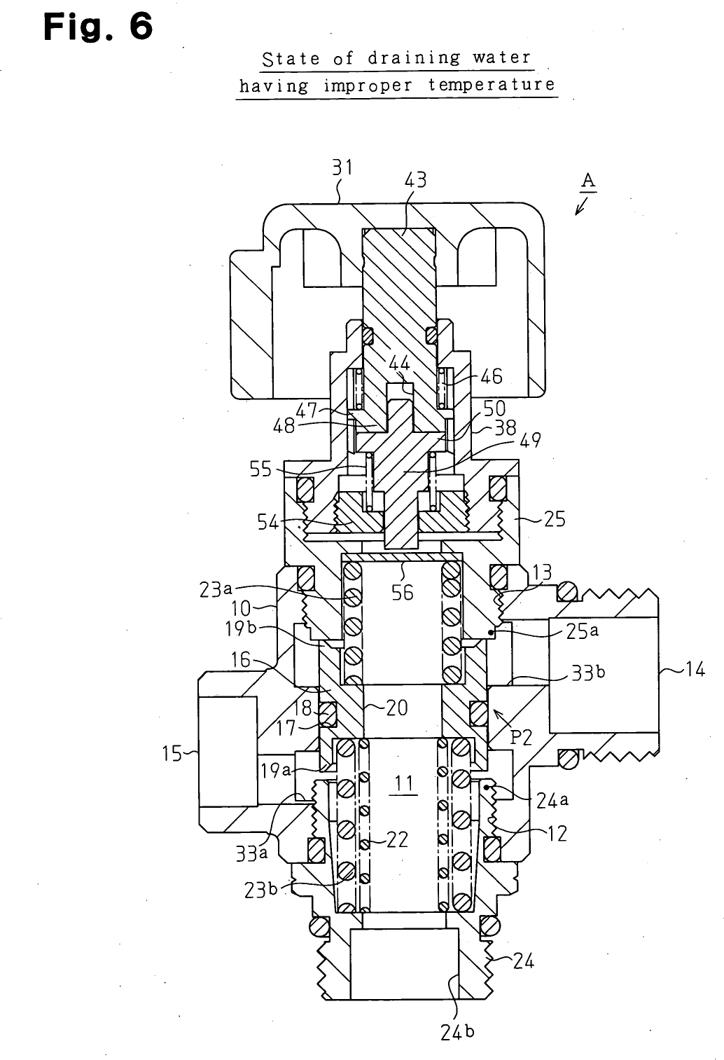

As shown in FIG. 6, when water having an improper temperature is supplied from the combination faucet 1 to the body 10 of the channel switching valve A in a state in which the tip of the rotatable body 49 is separated from the pressure plate 56 and the first temperature sensitive element 23a is not forcefully compressed from the outside, the valve body 16 is moved to the second position P2 so that the second end face 19b of the valve body 16 is seated on the second valve seat 25a in the second lid member 25. As a result, the discharge hole 14 is closed while the drain hole 15 is opened and thus water having a proper temperature is drained from the drain hole 15.

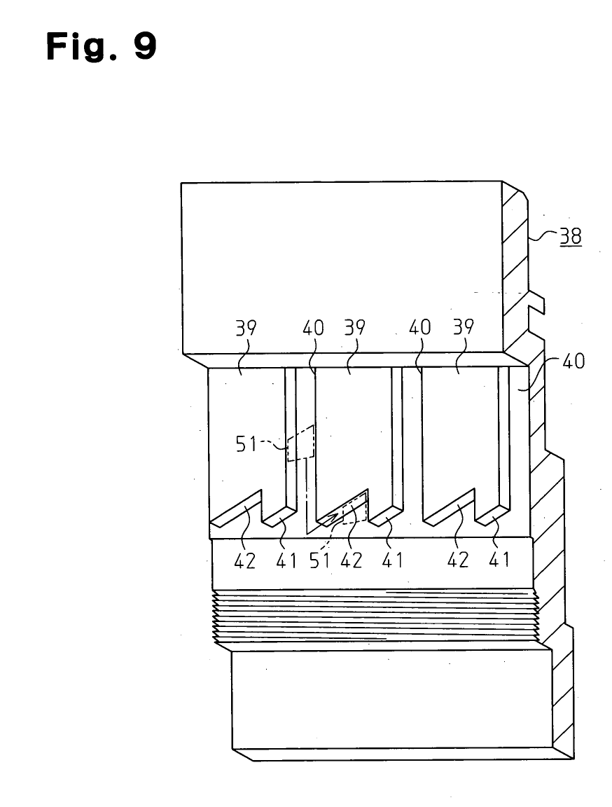

Then, a case will be described when water having an improper temperature flowing in the channel 11 of the body 10 is forcefully discharged from the discharge hole 14. When pushing the handle 31, the operating shaft 43 moves downwardly against biasing force of the coil spring 46 and the rotatable body 49 moves in the same direction. In this case, with movement of the operating shaft 43, the rotatable body 49 is rotated by a predetermined angle by engagement of the gable cam faces 48 and the inclined faces 52 such that the engaging protrusions 51 on the rotatable body 49 get out of the vertical grooves 40 of the tube body 38 and are engaged with the stopper parts 42, as shown in FIG. 9.

Therefore, even if the pushing operation of the handle 31 is released in this state, the rotatable body 49 is held in the lower position, although the handle 31 and the operating shaft 43 is moved to return to the upper position by the biasing force of the coil spring 46. Thus, as shown in FIG. 7, the first temperature sensitive element 23a is kept in a compressed state by the pressure plate 56 while the valve body 16 is forcefully moved to the first position P1. In this state, even if load generates on either of the temperature sensitive elements 23a, 23b, the valve body 16 does not return to the second position P2 because a large biasing force applies to the valve body 16 by compression of the first temperature sensitive element 23a. Therefore, the second valve hole 33b is kept opened and water having an improper temperature continues to be discharged from the discharge hole 14.

When pushing the handle 31 once again, the operating shaft 43 moves downwardly so that the rotatable body 49 is further rotated by a predetermined angle by engagement of the gable cam faces 48 and the inclined faces 52. As a result, the engaging protrusions 51 on the rotatable body 49 come off the stopper parts 42 of the tube body 38 and are inserted to engage into the vertical grooves 40. When the pushing operation of the handle 31 is subsequently released, the handle 31 and the operating shaft 43 move to return to the upper position by the biasing force of the coil spring 46 while the rotatable body 49 moves to return to the lower position due to the biasing force of the pressure spring 55.

As a result, as shown in FIG. 6, the pressure plate 56 is released from the pressure condition and the valve body 16 is moved to the second position P2 by the biasing forces of the bias spring 22 and the second temperature sensitive element 23b. However, because water having an improper temperature has flowed into the channel 11, the valve body 16 remains to be placed in the second position P2 and the first valve hole 33a is kept opened. Therefore, water having an improper temperature is drained from the drain hole 15.

Thus, each pushing operation of the handle 31 can alternately switch between a locked state in which the actions of the both temperature sensitive elements 23a, 23b and the bias spring 22 are deactivated by holding the valve body 16 in the first position P1 and an unlocked state in which their actions are activated by releasing the hold of the valve body 16. Therefore, one-touch switching is possible in comparison with the case of switching between the locked state and the unlocked state by rotating the handle 31 as shown in FIG. 1.

In this embodiment, the plug 28, the handle 31, the operating shaft 43, the rotatable body 49, the pressure spring 55 and the pressure plate 56 constitute lock means.

Then, a third embodiment of the present invention will be described with reference to the drawings. Points which are different from the first embodiment will now be mainly described and the same or similar components will be designated by the same reference symbol as in the first embodiment and description of the components will be omitted.

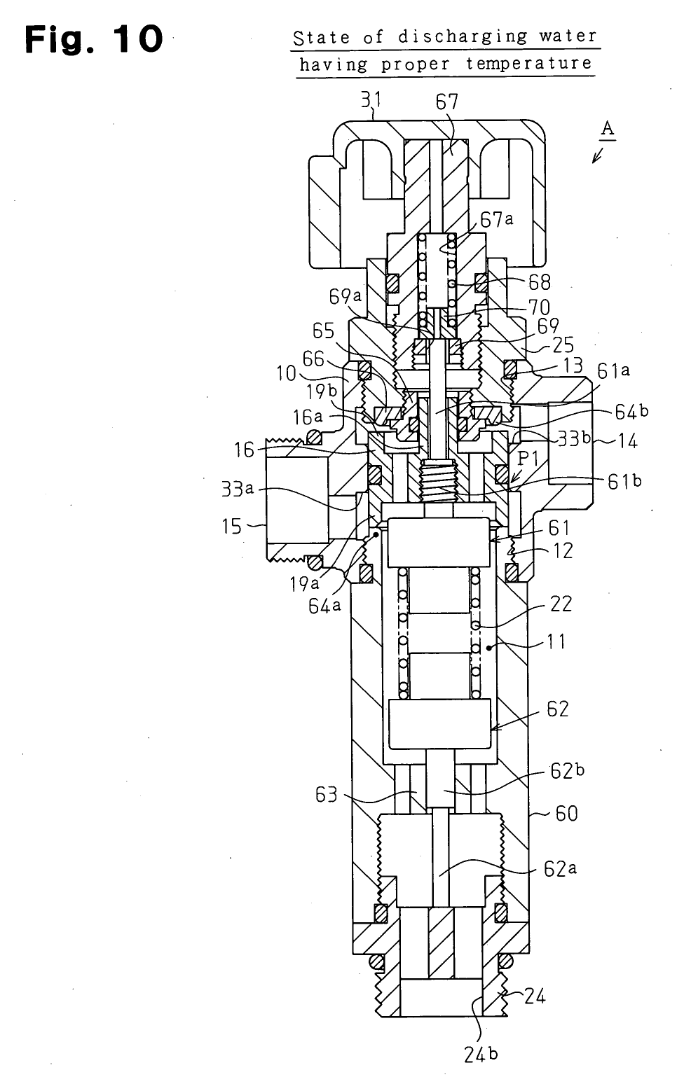

As shown in FIG. 10, a tube-like accommodating case 60 is provided between the body 10 and the first lid member 24. In the accommodating case 60, a first wax thermoelement 61 as a first temperature sensitive element and a second wax thermoelement 62 as a second temperature sensitive element are accommodated, which are spaced in the upstream side and the downstream side of the accommodating case 60. Each wax thermoelement 61, 62 comprises a piston rod 61a, 62a which changes its projecting amount as a function of the volume of wax varying with the temperature of shower water. In addition, in this embodiment, a valve casing is constituted by the body 10, the first lid member 24 and the second lid member 25.

The piston rods 61a, 62a of the wax thermoelements 61, 62 are pointed in opposite directions to each other. A tip of the piston rod 62a of the second wax thermoelement 62, which is pointed downward, is supported in the middle part of the first lid member 24 through which shower water can pass. A guide tube 62b for guiding the piston rod 62a is formed near the middle of the accommodating case 60. The guide tube 62b is slidably inserted into the center of the guide part 63 through which shower water can pass. Therefore, the second wax thermoelement 62 is supported so that it can move upwardly and downwardly.

On a top of the second wax thermoelement 62, the first wax thermoelement 61 is supported through the bias spring 22. The wax thermoelements 61, 62 can move close to or away from each other. A guide tube 61b which guides the piston rod 61a of the first wax thermoelement 61 is threaded to the middle part of the above described valve body 16. Therefore, the first wax thermoelement 61 and the valve body 16 move together. Valve body activating means is constituted by the bias spring 22, the first wax thermoelement 61 and the second wax thermoelement 62.

In this embodiment, the first valve seat 64a, to which the first end face 19a of the valve body 16 contacts when the valve body 16 is placed in the first position P1, is an end of the accommodating case 60. Further, the second valve seat 64b, to which the second end face 19b of the valve body 16 contacts when the valve body 16 is placed in the second position P2, is a circumference of the valve seat 66 which is attached by a pinching member 65 threadably engaged with the second lid member 25. In the middle part of the pinching member 65, a rod support part 16a is slidably inserted, which is provided to protrude from the middle part of the valve body 16. The purpose of arrangement in this way is to stably move the valve body 16, to which the first wax thermoelement 61 is attached, between the first position P1 and the second position P2.

A plug 67, to which the handle 31 is integrally attached, is threaded to the above described second lid member 25 so that the plug 67 can move forward and backward. A relief coil spring 68 is accommodated in an internal space 67a of the plug 67. One end of the relief coil spring 68 abuts the inner part of the internal space 67a and the other end is engaged with the moving body 70 provided on an adjuster 69 which is threaded to a lower end face of the plug 67. The relief coil spring 68 is set to have a spring constant larger than that of the bias spring 22 and biasing force of the relief coil spring 68 can be also adjusted by changing the threaded position of the adjuster 69. In a through hole 69a formed in the middle part of the adjuster 69, a tip of the piston rod 61a of the first wax thermoelement 61 is inserted so that the tip can contact the moving body 70.

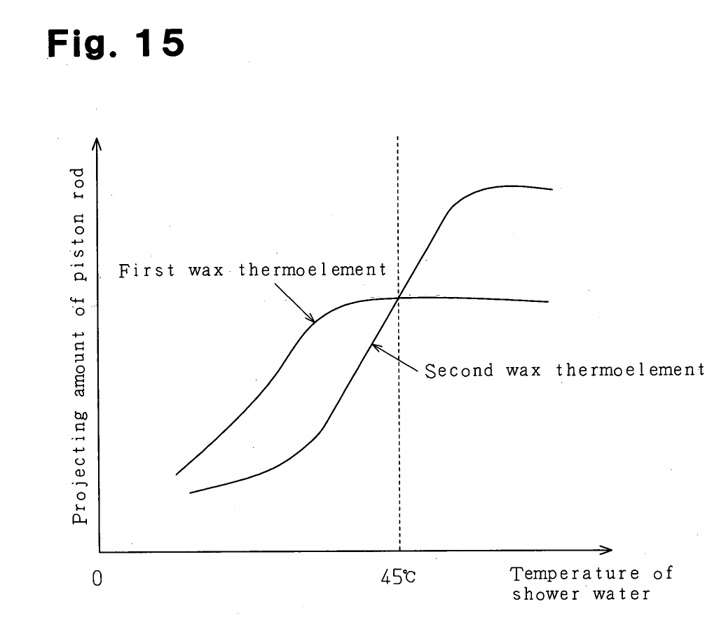

Temperature characteristics of each of the above described wax thermoelements 61, 62 will be described. The piston rods 61a, 62a of the wax thermoelements 61, 62, respectively, are set to have different projecting amounts depending on the temperature of shower water. That is, as shown in FIG. 15, when the temperature of shower water is lower than 45° C., the projecting amount of the piston rod 61a of the first wax thermoelement 61 is larger than the projecting amount of the piston rod 62a of the second wax thermoelement 62. When the temperature of shower water is higher than 45° C., the projecting amount of the second piston rod 62a is larger than the projecting amount of the first piston rod 61a. In addition, the piston rod 61a of the first wax thermoelement 61 is set to have the largest projecting amount and reach its stroke end when the temperature of shower water is 45° C. On the other hand, the piston rod 62a of the second wax thermoelement 62 is set to reach its stroke end when the temperature of shower water is higher than 45° C.

Therefore, as shown in FIG. 10, when water having a proper temperature flows into the channel 11 of the channel switching valve A, the piston rod 61a of the first wax thermoelement 61 hits against the moving body 70 before reaching its stroke end and reaches the stroke end in that state. Then, since the spring constant of the relief coil spring 68 is set to be larger than that of the bias spring 22, the first wax thermoelement 61 moves, due to thrust (load) of the piston rod 61a, in the opposite direction to the protrusion direction of the piston rod 61a so as to compress the bias spring 22 and therefore the valve body 16 is placed in the first position P1. As a result, the first valve hole 33a is closed while the second valve hole 33b is opened and thus water having a proper temperature flowing into the channel 11 is discharged from the discharge hole 14 through the second valve hole 33b.

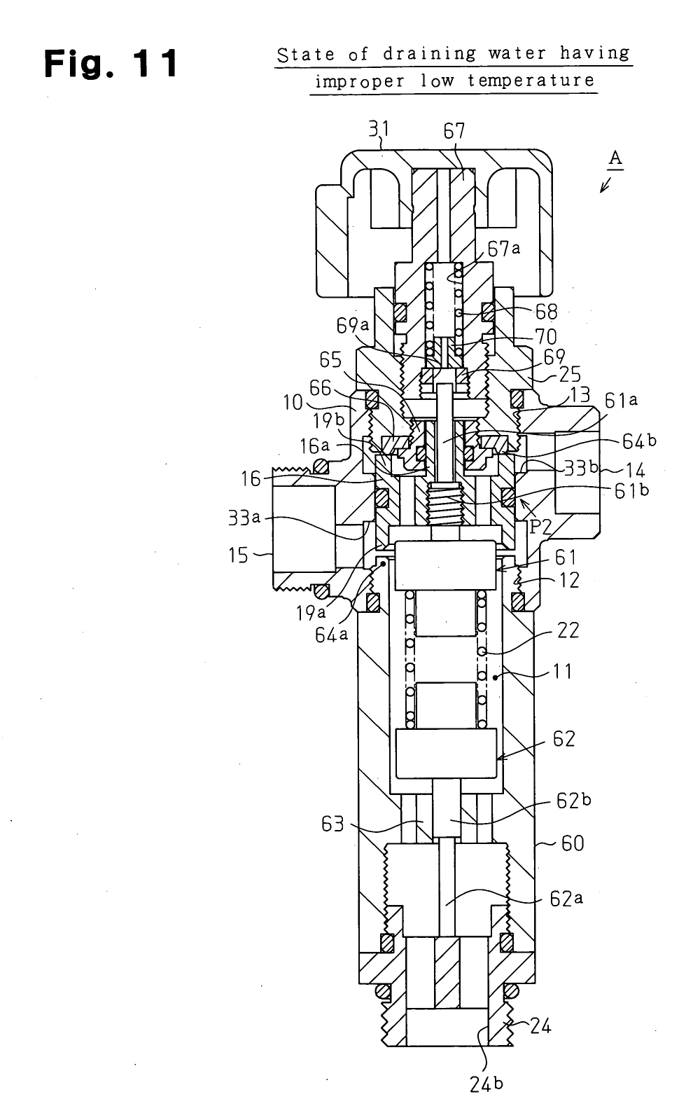

As shown in FIG. 11, when water having an improper temperature equal to or lower than 35° C. flows into the channel 11 of the channel switching valve A, the piston rod 61a of the first wax thermoelement 61 does not hit against the moving body 70 and therefore the valve body 16 is placed in the second position P2 by elastic force of the bias spring 22. As a result, the second valve hole 33b is closed while the first valve hole 33a is opened and thus water having a proper temperature flowing into the channel 11 is drained from the drain hole 15 through the first valve hole 33a.

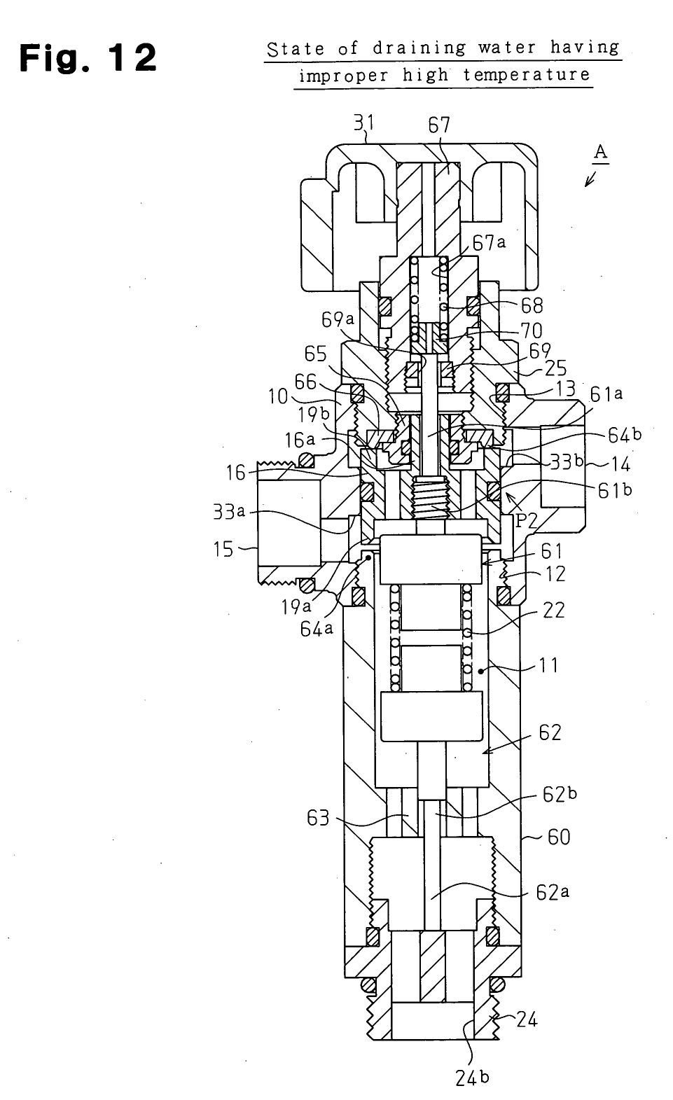

As shown in FIG. 12, when water having an improper temperature equal to or higher than 45° C. flows into the channel 11 of the channel switching valve, upward thrust (load) is provided by only the piston rod 62a of the second wax thermoelement 62 after the piston rod 61a of the first wax thermoelement 61 has reached its stroke end, such that the bias spring 22 is further compressed and the biasing force of the bias spring 22 becomes larger than the biasing force of the relief coil spring 68. Therefore, the first wax thermoelement 61 is pushed upwardly so that the valve body 16 is placed in the second position P2. As a result, the second valve hole 33b is closed while the first valve hole 33a is opened and thus water having an proper temperature flowing into the channel 11 is drained from the drain hole 15 through the first valve hole 33a.

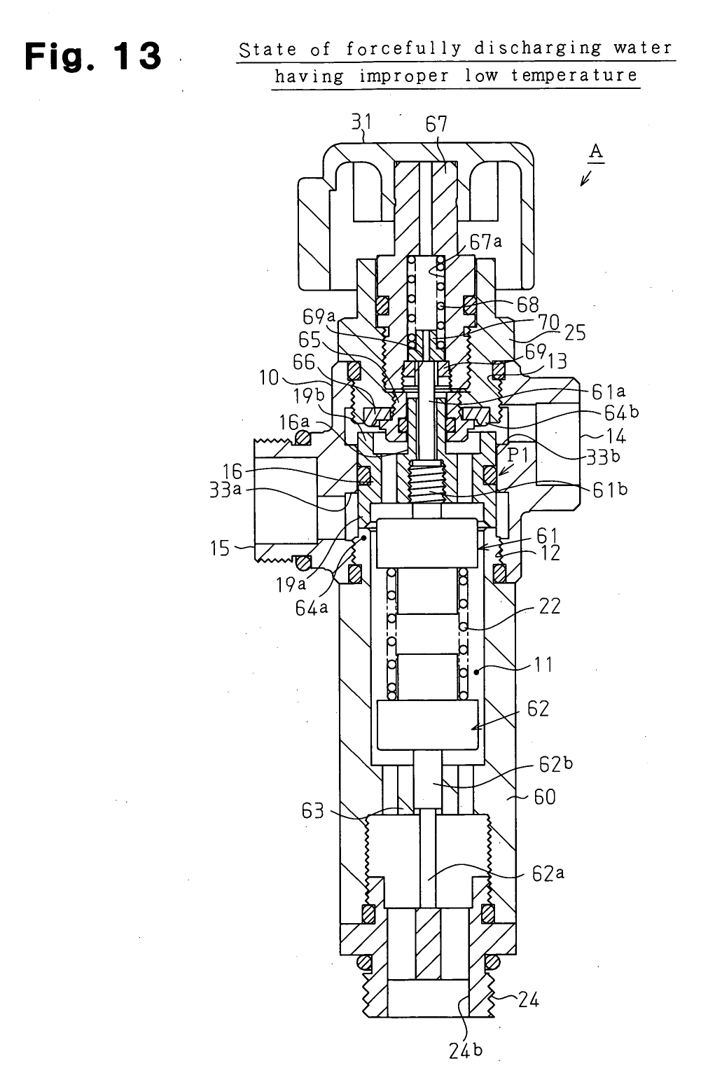

Then, a case will be described when water having an improper temperature flowing in the channel 11 is forcefully discharged from the discharge hole 14. When water having an improper temperature equal to or lower than 35° C. flows into the channel 11 of the channel switching valve A shown in FIG. 11, by rotating the handle 31 to tighten, the plug 67 rotates and approaches the first wax thermoelement 61 and the moving body 70 hits against the tip of the piston rod 61a, as shown in FIG. 13. When the moving body 70 is further moved in this state, the whole first wax thermoelement 61 is pushed downwardly against the biasing force of the bias spring 22, so that the valve body 16 is forcefully moved to the first position P1. As a result, the first valve hole 33a is forcefully closed while the second valve hole 33b is opened and thus water having an improper temperature is discharged from the discharge hole 14 to the side of the shower head 2, even though water having an improper temperature flows in the channel 11.

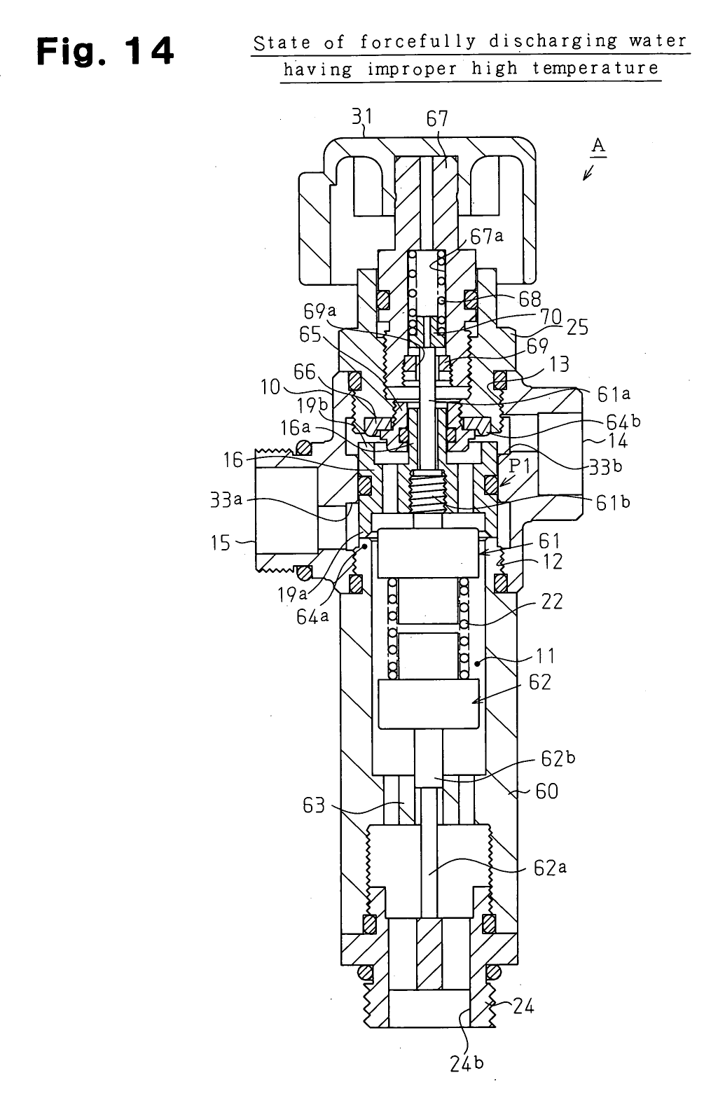

When water having an improper temperature equal to or higher than 45° C. flows into the channel 11 of the channel switching valve A shown in FIG. 12, by rotating the handle 31 to tighten it, the valve body 16 is forcefully placed in the first position P1 while keeping the state in which the tip of the piston rod 61a of the first wax thermoelement 61 hits against the moving body 70, as shown in FIG. 14. As a result, the first valve hole 33a is forcefully closed while the second valve hole 33b is opened and thus water having an improper temperature is discharged from the discharge hole 14 to the side of the shower head 2, even though water having an improper temperature flows in the channel 11.

Therefore, even if the valve body 16 is placed in the first position P1 due to assembly errors of the first wax thermoelement 61 or the like, when the piston rod 61a of the first wax thermoelement 61 has not reached its stroke end and has some space for further projection, projection of the piston rod 61a is permitted by the relief coil spring 68 being compressed. Therefore, it is possible to prevent a large extraction force from being applied a joint portion of the first wax thermoelement 61 and the valve body 16 and to achieve enhanced reliability. At the same time, the first valve hole 33a and the second valve hole 33b can be successfully opened and closed without being affected by assembly accuracy of the first wax thermoelement 61.

The above described embodiments may be modified as follows.

In the first and second embodiments, the first temperature sensitive element 23a may be placed inside the bias spring 22, instead of being placed outside the bias spring 22. The first and second temperature sensitive elements 23a, 23b may be plate springs, wires or the like, instead of coil springs.

Although, in the first and second embodiments, the first temperature sensitive element 23a extends when the temperature of shower water is higher than 35° C. and lower than 45° C. and the second temperature sensitive element 23b extends when the temperature of shower water is equal to or higher than 45° C., other temperature sensitive elements may be used which extend in different temperature regions from the above described temperature and also the temperature range in which water is considered to have a proper temperature may be changed. Also in the third embodiment, the temperature range in which water is considered to have a proper temperature may be changed by changing temperature characteristics for projection of the piston rods 61a, 62a of the respective wax thermoelement 61, 62.

Although, in the above described first to third embodiments, the valve body 16 is mechanically moved between the first position P1 and the second position P2 with the temperature sensitive elements 23a, 23b of shape memory alloy or the wax thermoelements 61, 62, the valve body 16 may be electrically moved with solenoid valves or the like, for example. In this case, a temperature sensor is provided on the body 10 in order to actuate the solenoid valves based on temperature sensing signals which are detected by the temperature sensors.

Although, in the above described embodiments, the second drain port for draining water having an improper temperature is provided in the upstream side of the channel and the first drain port for draining water having a proper temperature is provided in the downstream side, the positional relationship of the first and second drain ports may be changed.

A fluid is not limited to water (shower water) and it may be other liquid such as lubricating oil or gas such as air, for example.

The channel switching valve A may be applied to a warm-water bidet, for example, instead of a shower system in a bath.

1. A channel switching valve comprising: a valve casing, a valve body, and valve body activating means, wherein the valve casing includes:
a fluid supply port for supplying fluid into the valve casing;
a first drain port for draining fluid having a temperature out of a predetermined temperature range, which is supplied into the valve casing through the fluid supply port;
a second drain port for draining fluid having a temperature in the predetermined temperature range, which is supplied into the valve casing through the fluid supply port;
a first channel connecting the fluid supply port to the first drain port;
a second channel connecting the fluid supply port to the second drain port;
a first valve hole provided in the middle of the first channel;
a second valve hole provided in the middle of the second channel;
a first valve seat provided corresponding to the first valve hole; and
a second valve seat provided corresponding to the second valve hole,
wherein the valve body moves between a first position in which the valve body contacts the first valve seat to close the first valve hole and a second position in which the valve body contacts the second valve seat to close the second valve hole,
wherein the valve body activating means allows the valve body to be placed in the first position or the second position based on the temperature of the fluid,
wherein a part of the first channel and a part of the second channel are common, and wherein the channel switching valve further includes lock means for forcefully moving the valve body to the first position and holding the valve body in the first position.

2. The channel switching valve according to claim 1, wherein the valve body has a first end face and a second end face, the first end face is seated on the first valve seat when the valve body is located in the first position, and the second end face is seated on the second valve seat when the valve body is located in the second position, and the valve body is placed in the first and second channels.

3. The channel switching valve according to claim 1 or 2, wherein the valve body activating means includes a first temperature sensitive element biasing the valve body toward the first position, and a second temperature sensitive element and a bias spring biasing the valve body toward the second position, and biasing forces of the first temperature sensitive element and the second temperature sensitive element individually change depending on the temperature of the fluid and biasing force of the bias spring is independent of the temperature of the fluid, and if the temperature of the fluid is in the predetermined temperature range, the biasing force of the first temperature sensitive element is larger than the sum of the biasing force of the bias spring and the biasing force of the second temperature sensitive element, while if the temperature of the fluid is out of the predetermined temperature range, the biasing force of the first temperature sensitive element is smaller than the sum of the biasing force of the bias spring and the biasing force of the second temperature sensitive element.

4. The channel switching valve according to claim 1, wherein the lock means includes a handle, and every time a user operates the handle, the valve body switches between a locked state in which the valve body is held in the first position and an unlocked state in which the holding of the valve body in the first position is released.

5. The channel switching valve according to claim 1, wherein the first temperature sensitive element and the second temperature sensitive element are made of shape memory alloy and reversibly transform depending on the temperature of the fluid.

6. The channel switching valve according to claim 1, wherein the first temperature sensitive element and the second temperature sensitive element are wax thermoelements.

7. A shower system comprising: a channel switching valve including a valve casing, a valve body, and valve body activating means, wherein the valve casing includes:
a fluid supply port for supplying fluid into the valve casing;
a first drain port for draining fluid having a temperature out of a predetermined temperature range, which is supplied into the valve casing through the fluid supply port;
a second drain port for draining fluid having a temperature in the predetermined temperature range, which is supplied into the valve casing through the fluid supply port;
a first channel connecting the fluid supply port to the first drain port;
a second channel connecting the fluid supply port to the second drain port;
a first valve hole provided in the middle of the first channel;
a second valve hole provided in the middle of the second channel;
a first valve seat provided corresponding to the first valve hole; and
a second valve seat provided corresponding to the second valve hole,
wherein the valve body moves between a first position in which the valve body contacts the first valve seat to close the first valve hole and a second position in which the valve body contacts the second valve seat to close the second valve hole,
wherein the valve body activating means allows the valve body to be placed in the first position or the second position based on the temperature of the fluid,
wherein a part of the first channel and a part of the second channel are common, and
wherein the channel switching valve further includes lock means for forcefully moving the valve body to the first position and holding the valve body in the first position, and the shower system further comprising a hose and a shower head, with the shower head is connected to the first drain port of the channel switching valve through the hose.

8. A channel switching valve comprising: a body in which a channel is formed through which fluid passes, a discharge hole which is opened in the body to supply the fluid to a subsequent element, a drain hole which is opened in the body to drain the fluid if the temperature of the fluid is out of a predetermined temperature range, a valve body which is accommodated in the channel and opens or closes either a part of the channel connecting to the discharge hole or a part of the channel connecting to the drain hole, a first temperature sensitive element which is accommodated in the channel so as to bias the valve body in a predetermined direction, and a bias spring and a second temperature sensitive element which are accommodated in the channel so as to bias the valve body in a direction opposite to the predetermined direction, wherein biasing forces of the first temperature sensitive element and the second temperature sensitive element individually change depending on the temperature of the fluid, and if the temperature of the fluid is out of the predetermined temperature range, the valve body moves to allow the fluid to be drained from the drain hole due to the sum of the biasing force of the bias spring and the biasing force of the second temperature sensitive element being larger than the biasing force of the first temperature sensitive element, and a handle for forcefully moving the valve body in the channel, is connected to the valve body and by operating the handle, the valve body is moved to close the part of the channel connecting to the drain hole.
